(19) United States
(12) Patent Application Publication
(10) Pub. No.: US 2012/0221563 A1
(43) Pub. Date: Aug. 30, 2012

(54) Social Weight of Social Media Content

(75) Inventors: Nirveek De, Mountain View, CA (US); Roman Fuchs, San Francisco, CA (US); Ronald H. Jones, JR., Mountain View, CA (US); Stephane Karoubi, Mountain View, CA (US)

(73) Assignee: Microsoft Corporation, Redmond, WA (US)

(21) Appl. No.: 13/033,656

(22) Filed: Feb. 24, 2011

(51) Int. Cl. G06F 17/30

(52) U.S. Cl. 707/728; 707/E17.014

(57) ABSTRACT

Systems and methods for social weighting of content items from a plurality of content sources, such as the Internet, are described. Disclosed implementations include, but are not limited to, receiving a search request from a user, retrieving content items related to the search request to obtain a number of results, weighting the results according to at least one social factor, and providing the weighted results in response to the request.

### BACKGROUND

Search results typically rely upon rankings of items to determine the most relevant items to be presented to the user. These rankings may be based upon criteria such as the number of times a particular item was “clicked on” or viewed by a user. Furthermore, search results are commonly presented in chronological order and the assumed relevancy of the content to the search being performed. However, one reason that providing relevant search results in a chronological order for internet content is problematic is because the newest content is not always the most relevant content to a particular user.

### SUMMARY

Systems, methods and computer-readable media are disclosed herein that provide one or more ways of weighting social media content. Social media content is weighted by use of the following, either alone or in combination: content aging, content audience count, comments on content, links to the content, visitors to the content, contributors to the content, “likes” or other content ratings, and the like. It is noted that such social media weighting is not limited to the items listed above; rather, the items listed above may be combined with other content weighting items or methods now known or unknown in the art.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 illustrates an example of a client-server environment that can be used to implement one or more embodiments;

FIG. 2 is a block diagram of an example of a system according to one or more embodiments;

FIG. 3 depicts a flowchart of an example embodiment of determining the social weight of social media content; and

FIG. 4 depicts a flowchart of an example embodiment of responding to a request for a content item.

### DETAILED DESCRIPTION

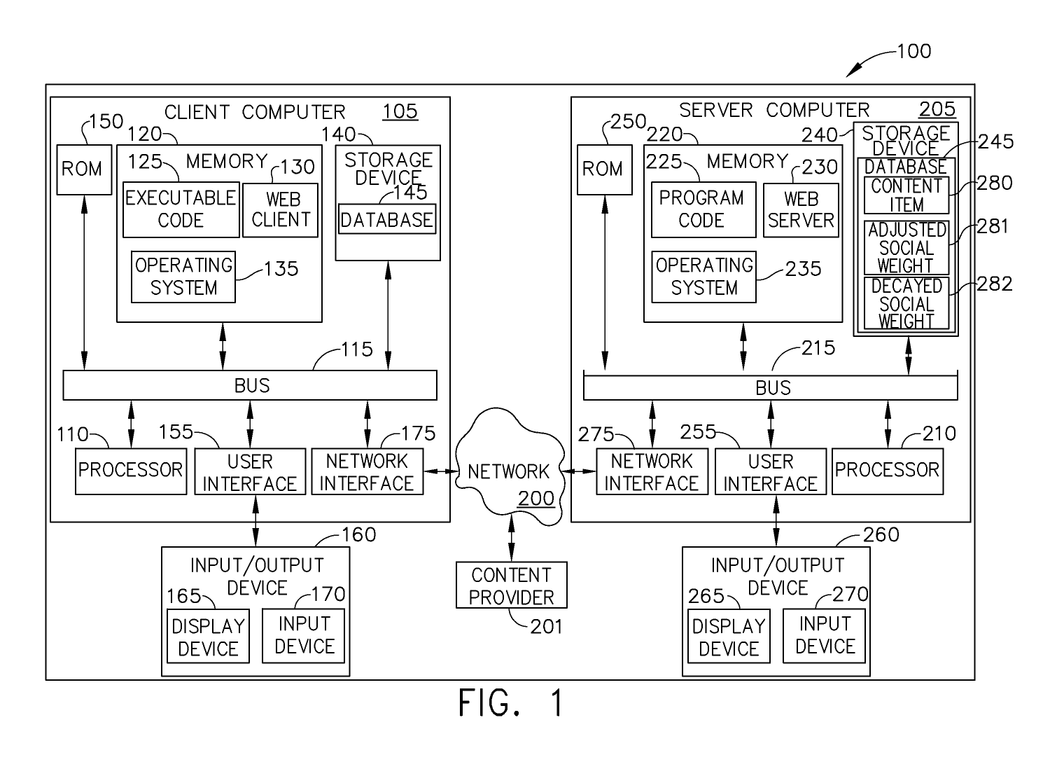

FIG. 1 shows an example of a client-server environment 100, including both software and hardware, that is suitable for implementing one or more of the embodiments described herein. The environment 100 includes at least one apparatus, such as at least one server computer 205 that interfaces with a plurality of client computers 105. Specifically, the server computer 205 is a web server that responds to requests from the client computer 105 while the client computer 105 is a web client that makes requests to the server computer 205. Each computer 105, 205 represents practically any type of computer, any type of combination of computers (e g., one or more networked computers in a cluster or other distributed computing system), or any type of programmable electronic device that is capable of functioning as a client and/or server.

Each computer 105, 205 includes at least one processor 110, 210, at least one bus 115, 215, and at least one memory 120, 220. Each of the processor 110, 210 is hardware based and represents the central processing unit (CPU) of the computer 105, 205. Furthermore, each of the processor 110, 210 may be a microprocessor that includes the majority or all of the functions of the CPU on a single integrated circuit or chip. Alternatively, each processor 110, 210 may represent a plurality of processors that operate in parallel such that the plurality of the processors are within the computer 105, 205 or a portion of the plurality of the processors is located on another coupled computer.

Each bus 115, 215 represents at least one of several types of bus structures, including a processor bus or local bus, a memory bus, an accelerated graphics port, and a peripheral bus, among others, to couple the various components together in each of the computer 105, 205.

Each memory 120, 220 represents the random access memory (RAM) of computer 105, 205 and typically stores executable code 125, 225. The executable code 125, 225 represents at least one instruction that is executed by the processor 110, 210, as well as any associated data (e.g., temporary variables or other intermediate data during the execution of the instructions), to implement the embodiments. The memory 120 also includes the instructions and data utilized for client computer 105 to function as a web client 130 (e g., a web browser). Likewise, memory 220 includes the data and instructions utilized for server computer 205 to function as a web server 230. Furthermore, each memory 120, 220 includes an operating system 135, 235 that controls the operation of computer 105, 205.

Each memory 120, 220 may also represent (a) any supplemental level of memory (e g., a cache memory, a non-volatile memory, a backup memory, programmable memory, flash memory, read-only memory, among others), (b) memory storage physically located elsewhere in computer 105, 205 such as in a cache memory in processor 110, 210, (c) any storage capacity such as a virtual memory stored on a storage device 140, 240, and/or (d) on another coupled computer. For instance, executable code 125, 225 may reside in the storage device 140, 240 prior to being loaded into memory 120, 220.

The storage device 140, 240 also includes at least one database 145, 245 for storing data, for example, in tables, indexes, etc. Furthermore, data may be stored in storage device 140, 240 from the implementation of the embodiments. For example, database 245 in the server computer 205 stores at least one content item 280, at least one adjusted social weight 281, and at least one decayed social weight 282. A content item or social media content includes, but is not limited to, articles, videos, presentations, files, documents, links, web pages, and other content available via the internet. Each storage device 140, 240 may include a hard disk drive for reading from and writing to a hard disk, a magnetic disk drive for reading from and writing to a removable magnetic disk, and an optical disk drive for reading from or writing to a removable optical disk such as a CD or other optical media. The storage device, whether a hard disk drive, a magnetic disk drive, an optical disk drive, or a combination thereof, is connected to the bus 115, 215 by an appropriate interface. The drives and their associated computer readable media provide nonvolatile storage of computer readable instructions, data structures, program modules and other data for the computer 105, 205. Alternatively, the storage device 140, 240 may be magnetic cassettes, flash memory cards, digital video disks, etc.

Furthermore, each computer 105, 205 includes a basic input/output system (BIOS) that contains the basic routines that help to transfer information within the computer 105, 205, such as during start-up, stored in ROM 150, 250.

It is worth noting that executable code 125, 225, executed by the processor 110, 210, typically resides on computer readable media. Computer readable media may take many forms, including but not limited to, storage media and transmission media. Examples of storage media include, but are not limited to, RAM, ROM, EEPROM, flash memory, optical disks (e g., CD-ROM and digital versatile disks (DVD), etc.), magnetic cassettes, magnetic tape, hard disk drives, magnetic disk storage, or any other magnetic medium, floppy disks, flexible disks, memory chip, cartridge, volatile and non-volatile memory devices, and other removable disks or any other medium which can be used to store the information and which can be accessed by computer 105, 205. Memory 120, 220, storage device 140, 240, and ROM 150, 250 are examples of storage type computer readable media. The storage type computer readable media may also be tangible and recordable, and are explicitly defined herein to exclude propagated data signals. Examples of transmission media include, but are not limited to, wired media such as coaxial cable(s), copper wire and optical fiber, and wireless media such as optic signals, acoustic signals, RF signals and infrared signals, and digital and analog communication link.

Each computer 105, 205 includes a user interface 155, 255 for interfacing with at least one input/output device 160, 260. Exemplary output devices include a display device 165, 265 such as a monitor, a speaker, and a printer. A user can enter commands and data into each computer 105, 205 through input device 170, 270 such as a keyboard, a pointing device, a microphone, joystick, game pad, and scanner.

Each computer 105, 205 also includes a network interface 175, 275 that permits two-way communication of information with other computers and electronic devices through network 200 such as the Internet. Network interface 175, 275 may be an integrated services digital network (ISDN) card, modem, LAN card, and any device capable of sending and receiving electrical, electromagnetic, optical, acoustic, RF or infrared signals. Network 200 may be public and/or private, wired and/or wireless, local and/or wide-area, or may be multiple, interconnected networks, among others. In client-server environment 100, client computer 105, one or more content providers 201, and server computer 205 are networked via network 200.

In an exemplary embodiment, processors 110, 210 of computer 105, 205 are programmed by means of executable code 125, 225 (e.g., the instructions) stored at different times in the various computer readable storage media of computer 105, 205. Executable code 125, 225 may be implemented as part of the operating system 135, 235 or an application, component, program, object, module or sequence of instructions, a data structure, a subset thereof, among other arrangements. At execution, executable code 125, 225 is loaded, at least partially, into the computer's primary memory (i e., memory 120, 220) from the computer's secondary memory, (i.e., storage device 140, 240) where it is stored, and when read and executed by processor 110, 210 in computer 105 205, executable code 125, 225 causes that computer to perform the steps to execute the embodiments. At least a portion of executable code 125, 225 may also execute on one or more processors in another computer coupled to computer 105, 205 via network 200, with processing to implement the functions of the embodiment allocated to multiple computers over a network.

More specifically, in some embodiments, client computer 105 transmits a request (e.g., an HTTP request) for content items 280 to server computer 205 via network 200. In exemplary embodiments, server computer 205 has previously calculated a social weight for a plurality of content items 280 from one or more content providers 201 (e g., internet sources or content sources), and adjusted the calculated social weight by applying a time penalty and a decay algorithm. For example, executable code 225 was previously loaded into memory 220 from storage device 240 and executed by processor 210 to calculate the social weight, adjusted social weight 281, and decayed social weight 282. Processor 210 then stored content item 280, adjusted social weight 281, and decayed social weight 282 in database 245 in server computer 205. Content items 280 in database 245 were then pre-ranked based on their corresponding adjusted social weight 281 and/or decayed social weight 282. Alternatively, the ranking may simply occur in response to a request (e.g., HTTP request) without pre-ranking. In response to the request from client computer 105, processor 210 searches database 245 and utilizes the stored data to transmit a response (e.g., HTTP response) with content items 280 in a ranked order that respond to the request from client computer 105 via network 200

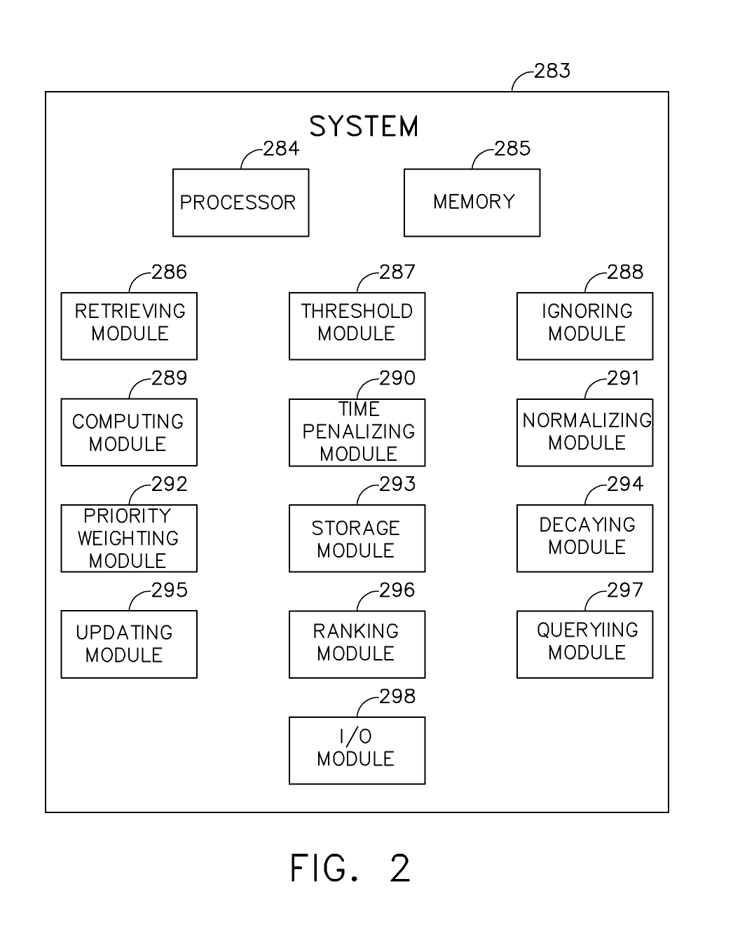

FIG. 2 shows an example of a system 283, such as server computer 205, including a processor 284 (such as processor 210 in FIG. 1), memory 285 (such as memory 220 in FIG. 1), and various modules which are stored in memory 285 and executed on processor 284. System 283 includes a Retrieving Module 286 that retrieves a pool of content items from one or more sources external to the system 283. System 283 also includes a Threshold Module 287 and an Ignoring Module 288. Threshold Module 287 is configured to analyze one or more data fields associated with a content item and compare the data field with a pre-determined threshold value for the data field. Ignoring Module 288 is configured to remove a content item not meeting the threshold from further processing by system 283.

System 283 further includes a Computing Module 289, a Time Penalizing Module 290, a Normalizing Module 291, and a Priority Weighting Module 292. Computing Module 289 is configured to compute a social weight using one or more data fields associated with a content item. Time Penalizing Module 290 is configured to adjust the social weight computed by Computing Module 289 to account for the age of the content item. Normalizing Module 291 is configured to apply a normalization factor to the social weight computed by the Computing Module 289 to account for variances in audience size and social activity from one content source to another. Priority Weighting Module 292 is configured to apply a pre-determined priority weight to the computed social weight of a content item based on the content source from which the content item was retrieved. Such priority weighting enables the system to favor certain content sources over other content sources. Time Penalizing Module 290, Normalizing Module 291, and Priority Weighting Module 292, alone or in combination, produce an adjusted social weight for a content item.

Also included in system 283 are a Storage Module 293, a Decaying Module 294, and an Updating Module 295. Storage Module 293 is configured to store the content item and data associated with the content item (e.g., the computed social weight, the adjusted social weight, and the age of the content item) in one or more databases. Decaying Module 294 is configured to apply a decay algorithm to the adjusted social weight of the content item after a pre-determined period of time, further accounting for the age of the content item as well as for the period of time the content item last experienced social activity. The application of the decay algorithm to the social weight stored with the content item in the database results in a decayed social weight. Updating Module 295 is configured to replace the social weight of the content item stored in the database with the decayed social weight.

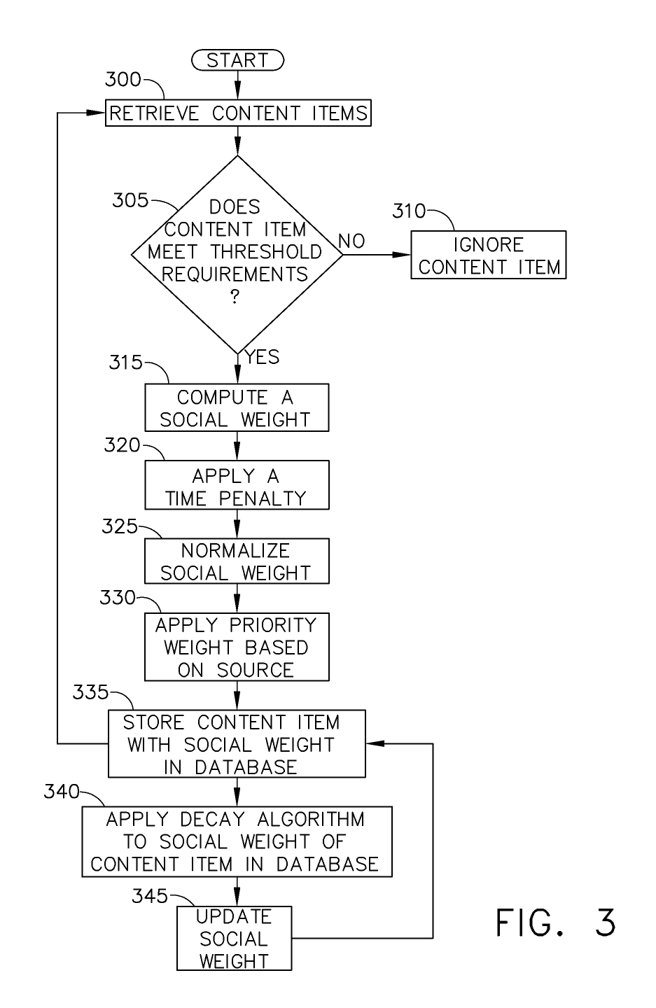

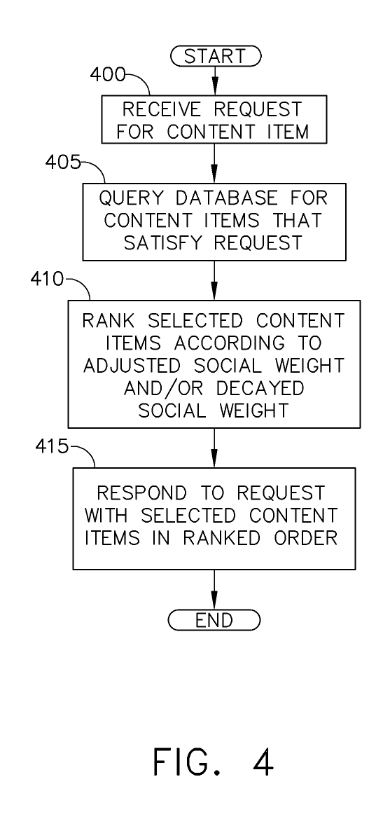

System 283 further includes Ranking Module 296 and Querying Module 297. Ranking Module 296 is configured to compare the social weights (e.g., adjusted social weight or decayed social weight) of the content items stored in the database and rank content items according to the social weight of the content item. Content items with a higher social weight are ranked above content items with a lower social weight. Querying Module 297 is configured to query the database in response to a received data transmission, such as a request, and retrieve a subset of content items that satisfy the request. System 283 also includes an I/O Module 298 that is configured to receive data transmissions from one or more sources external to system 283. I/O Module 298 may also be configured to transmit data transmissions to one or more external sources. Further functionality associated with one or more of the elements of system 283 recited above will be discussed in relation to the flow diagrams of FIGS. 3 and 4.

FIG. 3 shows an example of a method for determining social weight of social media content items. The example embodiment shown in FIG. 3 is a method for gathering, ranking and presenting the large amount of content available on the internet in a relevant way to a particular user. For example, the method can be used by a server to generate a listing of search results on a user's computer in response to a user's search query. At block 300, content items are retrieved by the Retrieving Module 286 of server computer 205 from a plurality of content sources (e.g., internet sources). Various methods for retrieving content items can be used depending on the specific embodiment, provided that information on the social elements of the content is available. Social elements can include, but are not limited to, the number of comments on the content item, the number of links to the content item, the number of visitors to the content item, the number of users contributing to the content item, the number of times the content item is shared, the number of “likes” for the content item, the number of reviews of the content item, and ratings for the content item. Social elements are representative of a content item's social currency, or the extent to which the content item is part of interactions within a community or social circle.

At block 305, the Threshold Module 287 of server computer 205 may determine if each content item meets a pre-determined minimum threshold. The pre-determined minimum threshold can vary depending on the specific embodiment, and can be based on comments, likes, views, or other social elements. Furthermore, the threshold can be based on any combination of social elements, such as a number of comments and a number of likes. For example, if a content item has ten comments on it, the content is further processed, but a content item not having at least ten comments will be ignored. In other embodiments, the threshold can be set such that content items with twenty (20) “likes” on it and ten comments is further processed, but content items with either fewer than twenty (20) “likes” or fewer than ten comments is ignored. In still other embodiments, either a minimum number of “likes” or a minimum number of comments is required for further processing. In yet other embodiments, the threshold may be based on a percentage of an audience. For example, the threshold may be set to ten comments for a source, but twenty-five (25) comments for another source with a larger audience. The threshold serves to ensure that the content being ranked is of minimum social relevance. Content items that do not meet the pre-determined minimum threshold are processed by Ignoring Module 288 and are ignored at block 310, removing them from further processing.

Content that meets the pre-determined minimum threshold may proceed to block 315 and a social weight is computed for that content item by Computing Module 289. A content item's social weight is representative of the relevancy of the content item in a social circle. Social circles are groups of socially interconnected people, and can include a user's family, friends, and acquaintances, co-workers, clients and customers, potential clients and customers, audiences, other users with the same or similar interest and preferences of the user, friends of the user's friends, and combinations and equivalents thereof, as well as macrocosms and microcosms of these groups. The social weight may be based on at least one of a number of comments on the content item, a number of links to the content item, a number of visitors to the content item, a number of users contributing to the content item, a number of times the content item is shared, a number of “likes” for the content item, a rating for the content item, the number of times the content item has been shared across various social media, or any combination and equivalents thereof, and represents the relevancy of the content item in a user's social circle. Moreover, only one of these social elements may be utilized to determine the social weight in some embodiments, while in other embodiments, a combination of more than one factor may be utilized. Other factors may also be utilized to determine the social weight. Such factors may include those described herein or other factors, known or unknown in the art, which could reasonably be determined to be helpful in deriving a social weighting factor.

In some embodiments, Computing Module 289 simply adds up the number of comments, the number of likes, and the number of times the content item has been shared and the resultant sum is the initial social weight for the content. Put another way, the quantities of each social element being taken into account for the social weight are summed. The specific combination of the social elements used to compute the social weight can vary depending on the specific embodiment, and can be more complex than simple addition in some cases. For example, in some embodiments, a “like” of the content item or a comment on the content item can be weighted more than a view of the content item. No matter how the social weight is initially determined, control may pass to block 320 in which Time Penalizing Module 290 applies a time penalty to the computed social weight.

The time penalty serves to adjust the effect of comment and like accumulation (as well as the accumulation of other social elements) over time. In other words, the time penalty enables newer content to be ranked above or among older content that has accumulated an increased social weight because of its time of existence on the internet, thereby accounting for the age of the content item. One manner by which a time penalty can be derived is based on an expression

$$f ( x ) = a {e}^{- \frac{{( x - b )}^{2}}{2 {c}^{2}}}$$

where x is the number of hours since the content item was created, a and b are decay coefficients, and c is the standard deviation. In example embodiments, a is equal to 1, b is equal to 0, and c is equal to 0.07. The decay coefficients can vary, for example, so long as the time penalty is between 0 and 1. When the time penalty is applied to the social weight, the social weight is multiplied by the time penalty.

Since different sources for content have varying audiences, the social weight may be normalized by Normalizing Module 291 at block 325 to account for a variance of audience size across the plurality of internet sources. Normalization can account for one or both the social activity of source users and the breadth of the audience. For example, the audience for an NFL® (registered trademark of the National Football League, New York, N.Y.) source might be much more “socially active” than the audience of a NATIONAL GEOGRAPHIC® (registered trademark of National Geographic Society, Washington, D.C.) source, resulting in increased comments, “likes,” and sharing for content retrieved from the NFL® source. In some embodiments, such as for content retrieved from FACEBOOK® (registered trademark of Facebook, Inc., Palo Alto, Calif.), the fan count of the page is used as the representative audience count. For other content sources, the number of unique users for a site, the number of page views, the number of subscribers to a source, or an average number of viewers over a number of pages can be used as the representative audience count. The information used to derive the audience count used for normalization can vary depending on the specific embodiment. In some embodiments, a logarithmic function might be applied to the audience count and used for normalization. For example, the normalization can be derived based on an expression

log_{1.141} n

where n is the audience count for a source. The log base can vary depending on the particular embodiment, and reduces any penalty applied to popular sources having a large audience count while still normalizing across sources.

At block 330, a priority weight may be applied by Priority Weighting Module 292 to the adjusted social weight for the particular content item. The priority weight is based on the particular internet source from which the particular content item was retrieved. The priority weights assigned to various sources can vary depending on the specific embodiment, or can be equal across sources. For example, in some embodiments, the default priority weight for all sources is equal to 1. In other embodiments, the priority weight for a particular source is greater than the priority weight for another source. For example, “more credible” sources can be given a greater priority weight than “less credible” sources, or the system can assign a greater priority weight to its partner's sources than to its competitor's sources.

After normalization, the application of the time penalty, and the application of a priority weight, the resultant social weight is referred to as an adjusted social weight for the content, though it should be noted that some embodiments will employ an adjusted social weight that has not been normalized, priority weighted, and/or time penalized. Furthermore, the particular order in which these steps are carried out by the server can vary depending on the specific embodiment. In some embodiments, the Normalizing Module 291 normalizes the social weight before Time Penalizing Module 290 applies the time penalty and Priority Weighting Module 292 applies the priority weight, while in other embodiments, Time Penalizing Module 290 applies the time penalty before Normalizing Module 291 normalizes the social weight and Priority Weighting Module 292 applies the priority weight. Furthermore, in still other embodiments, the method includes fewer than all of the steps of applying a time penalty, normalizing the social weight, and applying a priority weight.

Next, the server computer may proceed to block 335 in which Storage Module 293 stores the adjusted social weight for a content item with the content item in a social content database. The association of the adjusted social weight with the content allows content to be presented to users in a ranked order based on their adjusted social weights, with the content with the highest social weight being presented first and the content with the lowest social weight being presented last. The presentation of content can be triggered by a user logging into or viewing a site (i.e., the presentation of “trending” news or content) or as the result of a search (i.e., the search on a particular topic results in the content with increased social weight over content without social weight).

Next, at block 300, Retrieving Module 286 retrieves new content on a recurring basis. For example, approximately every fifteen (15) minutes, new content is retrieved by Retrieving Module 286 and the new content is processed according to the method described above. The time period for retrieving new content will vary depending on the particular embodiment and can be adjusted based on server limitations.

At block 340, Decaying Module 294 periodically applies a decay algorithm to the social weights associated with content items in the database. Both the time after which the decay begins to be applied for a content item and the frequency with which is it applied can vary. For example, in some embodiments, if a content item has not had social activity in the last hour, the algorithm can be applied about every fifteen (15) minutes to decay the social weight stored in the database, while in other embodiments, the social weight of the content is not decayed until there is no new social activity in the last twenty-four (24) hours. The decay algorithm can further account for the age of the content item and ensure that the ranking scheme presents current articles that are increasing in social relevance instead of older articles that were once extremely socially relevant. For example, the decay algorithm can ensure that an article on the results of the Presidential election decreases in relevance over time and does not appear in the top ranked results a year later, when it is less relevant, because it had a disproportionately high number of views or likes the day it originally appeared. The social weight may be updated at block 345 by Updating Module 295 and stored as the decayed social weight with the content item in the database by Storage Module 293 at block 335.

One manner in which the decay can be derived is based on an expression

D=0.06T+0.04A

where D is decay, T is the age of the content item and A is a representative time value of the last activity on the content item (e.g., time since the last comment or “like” occurred). Both T and A are represented in hours in some embodiments, but may be represented in a time unit other than hours (e g., weeks, days, minutes, etc.) in other embodiments. The constants can vary depending on the specific embodiment so long as each constant is between zero and one. One manner in which the decay algorithm may be applied to the adjusted social weight can be based on an expression

W=S(1−D)

where W is a decayed social weight for the particular content, S is the adjusted social weight for the particular content, and D is the decay. In embodiments where the value of D is negative, and the value of W is therefore negative, the value of W is set to zero. In other words, after a certain period of time, the decayed social weight becomes zero. The decayed social weight may then replace the social weight stored in the database with the content and be used by Ranking Module 296 to rank the content for presentation to the user. In some embodiments, the decay algorithm is applied in a plurality of iterations and the value of S for a subsequent iteration is the value of W from the previous iteration rather than the adjusted social weight as described above. Put another way, S is the social weight stored in the database with the content item, and can be the adjusted social weight originally stored to the database, a decayed social weight for the content item, or a social weight to which the decay algorithm has previously been applied.

In alternative embodiments, the social weight may be decayed according to a geometric progression. In such embodiments, the decay can be derived based on an expression

W=0.7S

where W is the decayed social weight for the particular content and S is the adjusted social weight for the particular content. As in the decay algorithm presented above, the constant can be adjusted depending on the specific application contemplated so long as it is between zero and one. In some embodiments, the constant is between about 0.5 and about 1. The use of a geometric progression to decay the social weight may result in a slower decay of the social weight as compared to the algorithm presented in the previous embodiment, and may ensure that if the retrieving process is stopped for a short while, the social weights for the existing articles are not all decayed to zero. The stopping of the retrieving process could occur for a number of unforeseen reasons, or during system or database maintenance or updating, for example. In some embodiments, the decay algorithm is applied by Decaying Module 294 in a plurality of iterations and the value of S for a subsequent iteration is the value of W from the previous iteration rather than the adjusted social weight as described above.

In an example embodiment, a server computer is communicatively coupled to the internet and Retrieving Module 286 retrieves content (i.e., a pool of content items), along with information on the social elements of each content item from a plurality of internet sources according to a pre-set time period, such as every fifteen (15) minutes. The server analyzes the number of “likes” and the number of comments of each content item to determine if each content item meets a pre-determined minimum threshold, which in this embodiment is ten comments. Content items in the pool of content items that have fewer than ten comments are ignored.

For each content item having ten or more comments, the Computing Module 289 of the server computer then calculates a raw social weight for the content item using the information on the social elements ingested with the content item. The server computer in this example embodiment weights comments such that each comment counts as five social elements, but where each “like” and page view counts as only one social element. The total number of social elements is the raw social weight for the given content item.

Next in this embodiment, the Time Penalizing Module 290 of server computer applies a time penalty to the raw social weight based on an expression

$$Y = R {e}^{- \frac{{x}^{2}}{0.0098}}$$

where Y is the time penalized social weight, R is the raw social weight, and x is the number of hours since the content item was created or posted on the internet.

In the next step according to this embodiment, the Normalizing Module 291 of the server computer normalizes the time penalized social weight according to the audience count for the internet source from which the content item was received by dividing the time penalized social weight by the audience count. The result of normalization is a normalized, time-penalized social weight.

The Priority Weighting Module 292 of the server computer next applies a priority weight to the content item, multiplying the normalized, time penalized social weight by the priority weight, to get an adjusted social weight. In this embodiment, the priority weight for each internet source is set to one, so the adjusted social weight for each content item is equal to the normalized, time-penalized social weight.

The Storage Module 293 of the server computer stores each content item from the pool of content items along with its adjusted social weight in the social weight database. Every fifteen (15) minutes (or whatever other time period is specified), the server computer repeats this process from retrieving content from internet sources to saving the processed content items in the database with adjusted social weights.

Periodically, such as every twenty (20) minutes or any other specified period, the Decaying Module 294 of the server computer applies a decay to the social weights of content items that have not received new social activity in a pre-determined amount of time. For example, the Decaying Module 294 decays the social weights of content items that have not had new social activity (e.g., no new comments, likes, or page views) in the last hour. For those content items, the server computer calculates a decayed social weight W according to an expression

W=S(1−(0.06T+0.04A))

where T is the age of the content item and A is a representative time value of the last activity on the content item (e.g., time since the last comment, page view, or “like” occurred), and S is the social weight stored with the content item in the database. Both T and A are represented in hours. The Updating Module 295 of the server computer replaces the social weight saved with the content item in the database with the decayed social weight. In this way, as more time passes during which a content item does not experience new social activity, its social weight used for ranking is decreased. In exemplary embodiments, the Ranking Module 296 ranks content items according to their adjusted social weights and/or decayed social weights.

In the example embodiment shown in FIG. 4, when a user enters one or more search terms in a search engine operating on the server computer using a client computer communicatively coupled via the internet or another network, the I/O Module 298 of the server computer receives the request including the search terms, as shown at block 400. Control passes to block 405 in which the Querying Module 297 of the server computer queries the database for content items that satisfy the request. In other words, the server computer determines which content items in the database match or could match the search terms entered by the user. At block 415, the Ranking Module 296 ranks the content items that satisfy the request based on their social weights. In some embodiments, all content items are ranked based on their adjusted social weights and/or decayed social weights and stored with their ranking in the database, and only the portion of content items that satisfy the request are included in the response. In other embodiments, only the content items that match the search terms are ranked. At block 415, the I/O Module 298 of the server computer responds to the request presenting the selected content items to the user in ranked order with the content item with the highest social weight at the top and in order of decreasing social weight. Those of ordinary skill in the art will appreciate that the server computer may respond with a representation of the content item such as a link to the content item, a thumbnail of the content item, etc.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments presented should not be limited by any of the above-described exemplary embodiments, but should be defined only in accordance with the following claims and their equivalents.

What is claimed is:

1. A computer implemented method for determining social weights for content items available from a plurality of content sources, the method comprising the steps of:
retrieving the content items from the plurality of content sources;
computing on a processor a social weight for a first content item, the social weight representing the relevancy of the first content item in a social circle;
applying a time penalty to the computed social weight for the first content item, the time penalty accounting for an age of the first content item; and
normalizing the computed social weight for the first content item based on an audience count for the content source from which the first content item was retrieved to account for a variance of audience size across the plurality of content sources, the steps of applying the time penalty and normalizing the computed social weight resulting in an adjusted social weight for the first content item.

2. The method of claim 1, the social weight being based on at least one of a number of comments on the first content item, a number of links to the first content item, a number of visitors to the first content item, a number of users contributing to the first content item, a number of times the first content item is shared, a number of likes for the first content item, or a rating for the first content item.

3. The method of claim 1 further comprising utilizing a threshold to determine whether to compute the social weight.

4. The method of claim 1, applying a time penalty before normalizing.

5. The method of claim 1 further comprising the steps of:
computing a social weight for a second content item, the social weight representing the relevancy of the second content item in the social circle;
applying a time penalty to the computed social weight for the second content item; and
normalizing the computed social weight for the second content item based on an audience count for the content source from which the second content item was retrieved, the steps of applying the time penalty and normalizing the computed social weight resulting in an adjusted social weight for the second content item.

6. The method of claim 5 further comprising the step of ranking the first content item and the second content item based on the adjusted social weight of each content item, the content item having a higher adjusted social weight being ranked above the content item having a lower adjusted social weight.

7. The method of claim 1 further comprising the steps of:
storing the first content item and the adjusted social weight in a database;
periodically applying a decay algorithm to the adjusted social weight for the first content item saved in the database to produce a decayed social weight for the first content item, the decay algorithm further accounting for the age of the first content item; and
replacing in the database the adjusted social weight for the first content item with the decayed social weight for the first content item.

8. The method of claim 7 further comprising the steps of:
computing a social weight for a second content item, the social weight representing the relevancy of the second content item in the social circle;
applying a time penalty to the computed social weight for the second content item;
normalizing the computed social weight for the second content item based on an audience count for the content source from which the second content item was retrieved; the steps of applying a time penalty and normalizing the computed social weight resulting in an adjusted social weight for the second content item; and
ranking the first content item and the second content item based on the adjusted social weight of second content item and the decayed social weight of the first content item.

9. The method of claim 7, the decay algorithm being
D=0.06T+0.04A
where D is decay, T is an age of the first content item and A is a representative time value of last activity on the first content item.

10. The method of claim 9 further comprising the step of applying the decay algorithm to the adjusted social weight of the first content item a plurality of iterations based on an expression
W=S(1−D)
where in the first iteration of the plurality of iterations, W is a decayed social weight for the first content item, S is the adjusted social weight for the first content item, and D is the decay; and the value of S for any subsequent iteration being the value of W from the previous iteration.

11. The method of claim 1, the time penalty being based on an expression
$$f ( x ) = a {e}^{- \frac{{( x - b )}^{2}}{2 {c}^{2}}}$$
where x is a number of hours since the first content item was created, a and b are decay coefficients, and c is the standard deviation.

12. The method of claim 11 where a is equal to 1, b is equal to 0, and c is equal to 0.07.

13. The method of claim 1 further comprising the step of applying a priority weight to the computed social weight for the first content item, the priority weight being based on the content source from which the first content item was retrieved; the steps of applying the time penalty, normalizing the computed social weight, and applying a priority weight resulting in the adjusted social weight for the first content item.

14. The method of claim 13, the priority weight for substantially all content sources being substantially equal to 1.

15. A system for social weighting content items retrieved from a plurality of content sources, comprising:
at least one hardware-based processor;
memory;
a retrieving module, stored in the memory and executable on the processor, configured to retrieve the content items from the plurality of content sources;
a computing module, stored in the memory and executable on the processor, configured to compute a social weight for a first content item, the social weight representing the relevancy of the first content item in a social circle;
a time penalizing module, stored in the memory and executable on the processor, configured to apply a time penalty to the computed social weight for the first content item, the time penalty accounting for an age of the first content item; and
a normalizing module, stored in the memory and executable on the processor, configured to normalize the computed social weight for the first content item based on an audience count for the content source from which the first content item was retrieved to account for a variance of audience size across the plurality of content sources, application of the time penalty and normalization the computed social weight resulting in an adjusted social weight for the first content item.

16. The system of claim 15, the computing module further configured to compute a social weight for a second content item, the social weight representing the relevancy of the second content item in the social circle, the time penalizing module further configured to apply a time penalty to the computed social weight for the second content item, the normalizing module further configured to normalize the computed social weight for the second content item based on an audience count for the content source from which the second content item was retrieved; the application of a time penalty and normalization of the computed social weight resulting in an adjusted social weight for the second content item, the system further comprising:
a ranking module, stored in the memory and executable on the processor, configured to rank the first content item and the second content item based on the adjusted social weight of each content item.

17. The system of claim 15 further comprising:
a storage module, stored in the memory and executable on the processor, configured to store the first content item and the adjusted social weight in a database;
a decaying module, stored in the memory and executable on the processor, configured to periodically apply a decay algorithm to the adjusted social weight for the first content item stored in the database to produce a decayed social weight for the first content item, the decay algorithm further accounting for the age of the first content item; and
an updating module, stored in the memory and executable on the processor, configured to replace in the database the adjusted social weight for the first content item with the decayed social weight for the first content item.

18. The system of claim 15, the social weight being based on at least one of a number of comments on the first content item, a number of links to the first content item, a number of visitors to the first content item, a number of users contributing to the first content item, a number of times the first content item is shared, a number of likes for the first content item, or a rating for the first content item.

19. The system of claim 15 further comprising a priority weighting module, stored in the memory and executable on the processor, configured to apply a priority weight to the computed social weight for the first content item, the priority weight being based on the content source from which the first content item was retrieved; the application of the time penalty, the normalization of the computed social weight, and application of a priority weight resulting in the adjusted social weight for the first content item.

20. One or more computer-readable storage media storing computer-executable instructions that, when executed by a processor, perform steps comprising:
receiving a request for information related to content items;
retrieving a plurality of content items related to the request from a plurality of content sources and storing at least a portion of the content items on one or more computer-readable media;
computing a social weight for the plurality of content items stored in the computer-readable media, the social weight representing the relevancy of each content item in a social circle;
applying a time penalty to the computed social weight for each content item of the plurality of content items, the time penalty accounting for an age of each content item;
normalizing the computed social weight for each content item in the plurality of content items based on an audience count for the content source from which each content item was retrieved to account for a variance of audience size across the plurality of content sources; the steps of applying the time penalty and normalizing the computed social weight resulting in an adjusted social weight for each content item;
ranking the content items of the plurality of content items according to the adjusted social weight for each content item to derive one or more ranked content items; and
responding to the request with at least one of the ranked content items.
